(19) United States
(12) Patent Application Publication
(10) Pub. No.: US 2013/0070458 A1
(43) Pub. Date: Mar. 21, 2013

(54) HEAT DISSIPATING DEVICE FOR LED BULB AND LED BULB WITH HIGH HEAT DISSIPATION

(71) Applicant: Jie Shi, Nanjing City (CN)

(72) Inventor: Jie Shi, Nanjing City (CN)

(21) Appl. No.: 13/700,401

(22) PCT Filed: Sep. 30, 2010
(86) PCT No.: PCT/CN2010/077504

§ 371 Date: Nov. 27, 2012

(30) Foreign Application Priority Data
May 27, 2010 (CN) 201020205124.0

(51) Int. Cl. F21V 29/00; F28F 3/02

(52) U.S. Cl. CPC F21V 29/004; F28F 3/025
USPC 362/235; 362/249.02; 165/185

(57) ABSTRACT

A heat dissipating device (1) for LED bulb includes a base (11) and two or more heat dissipating bodies (12). The heat dissipating bodies (12) are uniformly arranged around a central axis of the base, and a certain space is left between adjacent heat dissipating bodies (12), so that heat dissipating channels (13) radiating outwardly from the central axis of the base are formed. A cross section of the heat dissipating bodies (12) is V-shaped. An LED bulb comprising the heat dissipating device (1) is further provided, wherein LED light source module (2) is fixed on the heat dissipating bodies (12).

### RELATED APPLICATION DATA

This application is the national stage entry of International Appl. No. PCT/CN2010/077504, filed Sep. 30, 2010, which claims priority to Chinese Patent Application No. 201020205124.0, filed May 27, 2010. All claims of priority to these applications are hereby made, and each of these applications is hereby incorporated in its entirety by reference.

### TECHNICAL FIELD

The present invention relates to the technical field of semiconductor lighting, and more particularly, to a heat dissipating device for LED bulb and an LED bulb with high heat dissipation. The LED bulb is the one that uses Light-emitting Diode (LED) as light resource.

### BACKGROUND OF THE INVENTION

Under the background of rising worries about the shortage of global energy, saving energy is one of the most important problems we will confront in future. As a kind of light source with high efficiency, Light-emitting Diode (LED) has the advantages of long life, low energy consumption, and being energy saving, environmentally friendly, small in size, and so on. It is widely used in automobiles, traffic lights, screen, and even in lighting field. The LED bulb uses Light-emitting Diode (LED) as light resource. Compared with the filament lamp and the fluorescent lamp, the LED bulb for lighting, which uses LED as light resource, has an electricity-saving ratio of over 70 percent.

More and more bulbs are demanded along with the development of applications. An inherent character of the solid light source is that the higher the power of the LED bulb is, the more heat it generates. Whether the heat generated can be conducted or dissipated in time has become an important factor that affects the lighting qualities and service life of LED bulb.

The LED bulb in the prior art mainly comprises a lamp holder, a lamp adapter, a driver, a heat dissipating device, LED light source modules, light transmitting shades and so on.

As for a kind of LED bulb, it is provided with a reflecting device for light distribution. LED light source modules are provided at one side of the base plate, and the heat dissipating fins are provided at the other side of the base plate. All heat can be dissipated only through the heat dissipating fins provided at the other side of the base plate. It has the disadvantages that the heat dissipating area is small and its power can't be increased. The general output light flux of the LED bulb is low and the light loss of light distribution caused by the reflecting device is a lot, leading to a low efficiency of the general system.

As for another kind of LED bulb, the LED light source is integrated on a core pole and enclosed in a shell. All heat can be dissipated only through the outer part of the core pole which extends outside of the closed shell. The disadvantages of the LED bulb are that the efficiency of heat dissipating is low, its power can't be increased, the general output light flux of the LED bulb is low and it is difficult to meet the customer's demands.

The heat dissipating performance of the LED bulb in the prior art is not good and it is difficult to ensure the lighting quality and the service life of the LED bulb.

### SUMMARY OF THE INVENTION

The present invention aims at providing a heat dissipating device for LED bulb, which has simple and unique structure and good effect of heat dissipating. The heat dissipating device comprises a base and two or more heat dissipating bodies; the two or more heat dissipating bodies are uniformly arranged around a central axis of the base; and a certain space is left between adjacent heat dissipating bodies, so that heat dissipating channels radiating outwardly from the central axis of the base are formed.

The technical schemes can be improved through the following schemes:

The heat dissipating body has a V-shaped cross section; an apex of the V-shaped cross section of the heat dissipating body points to the central axis of the base, and an opening of the V-shaped cross section of the heat dissipating body points outwards relative to the central axis of the base.

An angle of each opening of the V-shaped cross section of the heat dissipating body is ranged from 10° to 180°.

The present invention also aims at providing an LED bulb with high heat dissipation, which has simple structure and good effect of heat dissipating. The LED bulb with high heat dissipation comprises a heat dissipating device and LED light source modules; the heat dissipating device comprises a base and two or more heat dissipating bodies; the two or more heat dissipating bodies are uniformly arranged around a central axis of the base; a certain space is left between adjacent heat dissipating bodies, so that heat dissipating channels radiating outwardly from the central axis of the base are formed; and the LED light source modules are fixed on the heat dissipating bodies.

The technical schemes can be improved through the following schemes:

The heat dissipating body has a V-shaped cross section; an apex of the V-shaped cross section of the heat dissipating body points to the central axis of the base, and an opening of the V-shaped cross section of the heat dissipating body points outwards relative to the central axis of the base.

Each LED light source module is fixed at a bottom and/or on two side walls of an interior of the heat dissipating body with V-shaped cross section; reflecting shades are provided at the bottom and on the two side walls of the interior of the heat dissipating body with V-shaped cross section.

The LED bulb with high heat dissipation further comprises light transmitting shades; and each light transmitting shades is buckled on a respective one of the heat dissipating bodies and covers the LED light source module therein.

The heat dissipating device for LED bulb of the present invention has simple and reasonable structure. It is completely new and unique, and has good effect of heat dissipating.

The LED bulb with high heat dissipation of the present invention is a dramatic breakthrough and innovation for the LED bulb in the prior art. By means of heat dissipating space (namely the heat dissipating channels) developed in the area of light source, the heat dissipating part and the lighting part of the LED bulb are well integrated, which solve the problem of less heat dissipating space due to small volume of the LED bulb, and prolong the service life of the LED bulb. The LED bulb with high heat dissipation is easy to assemble, and it has low production cost, and an aesthetic appearance.

### BRIEF DESCRIPTION OF THE DRAWINGS

FIG. 1 is a structural view illustrating the heat dissipating device for LED bulb of the present invention;

FIG. 2 is a sectional view of the heat dissipating bodies of the heat dissipating device shown in FIG. 1;

FIG. 3 is a perspective view illustrating the LED bulb with high heat dissipation of the present invention;

FIG. 4 is another perspective view illustrating the LED bulb with high heat dissipation shown in FIG. 3;

FIG. 5 is a sectional view of the LED bulb with high heat dissipation shown in FIG. 3;

FIG. 6 is a sectional view of the heat dissipating bodies of the heat dissipating device of the LED bulb with high heat dissipation shown in FIG. 3.

The elements in the above figures are denoted as follows:

| 1: heat dissipating device; | 11: base; | 12: heat dissipating |
|---|---|---|
| | | body; |
| 13: heat dissipating channel; | 14: heat dissipating fin; | |
| 15: heat dissipating cavity; | 2: LED light source module; | |
| 3: reflecting shade; | 4: light transmitting shade; | |
| 5: driver; | 6: lamp holder; | 7: lamp adapter. |

### DETAILED DESCRIPTION OF THE PREFERRED EMBODIMENT

In order to make the object, the technical schemes and the benefits of the present invention clearer, the heat dissipating device for LED bulb and LED bulb with high heat dissipation of the present invention will be described in more details with reference to the accompanying drawings and the preferred embodiments. It will be understood that the preferred embodiments of the present invention described below are not intended to limit the present invention, but intended to interpret the present invention.

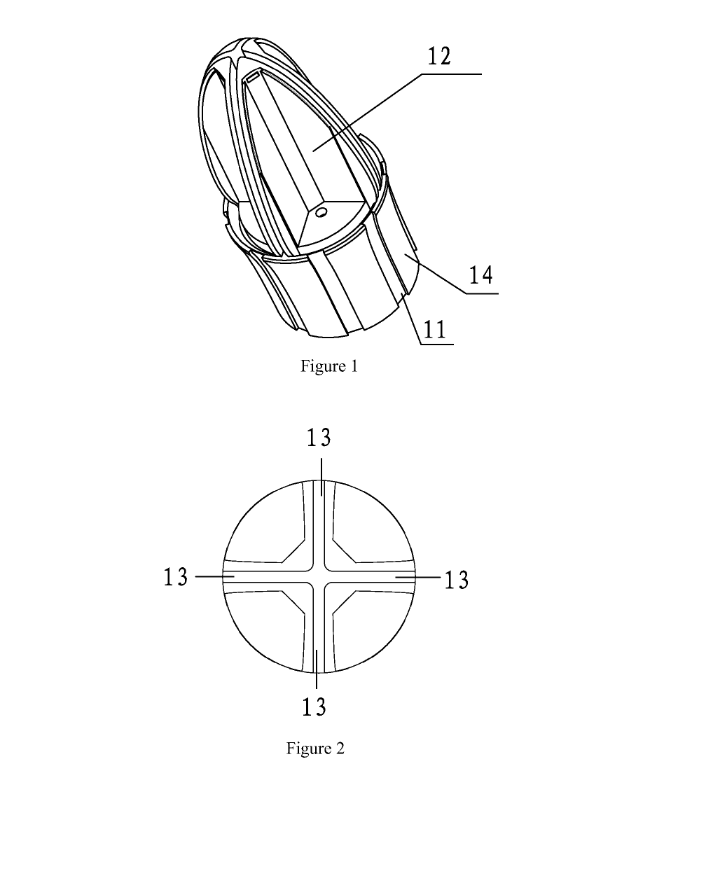

As shown in FIGS. 1 and 2, in one embodiment of the present invention, the heat dissipating device 1 for LED bulb comprises a base 11 and two or more heat dissipating bodies 12. Each heat dissipating body 12 extends along the central axis of the base. The two or more heat dissipating bodies 12 are uniformly arranged around the central axis of the base, and a certain space is left between adjacent heat dissipating bodies 12, so that heat dissipating channels 13 radiating outwardly from the central axis of the base are formed.

Preferably, the space between the adjacent heat dissipating bodies 12 is ranged from 0.5 mm to 20 mm, namely, width of a heat dissipating channel 13 is ranged from 0.5 mm to 20 mm In this embodiment, the space between the adjacent heat dissipating bodies 12 is 2 mm, namely, the width of the heat dissipating channel 13 is 2 mm.

As shown in FIG. 2, in this embodiment, four heat dissipating bodies 12 with V-shaped cross section are provided. The apex of the V-shaped cross section of the heat dissipating body 12 points to the central axis of the base, and the opening of the V-shaped cross section of the heat dissipating body 12 points outwards relative to the central axis of the base. A hollow heat dissipating cavity 15 is constructed at one side of the base, opposite to the side where heat dissipating bodies are disposed.

Preferably, the heat dissipating device 1 further includes a plurality of heat dissipating fins 14, and the base 11 is cylindrical. The heat dissipating fins 14 extend outwards from the outer wall of the cylindrical base 11.

Preferably, four to thirty heat dissipating fins 14 are provided. Preferably, the angle of each opening of the V-shaped cross section of the heat dissipating body is ranged from 10° to 180°. In this embodiment, the angle of the opening of the V-shaped cross section of the heat dissipating body is 90°.

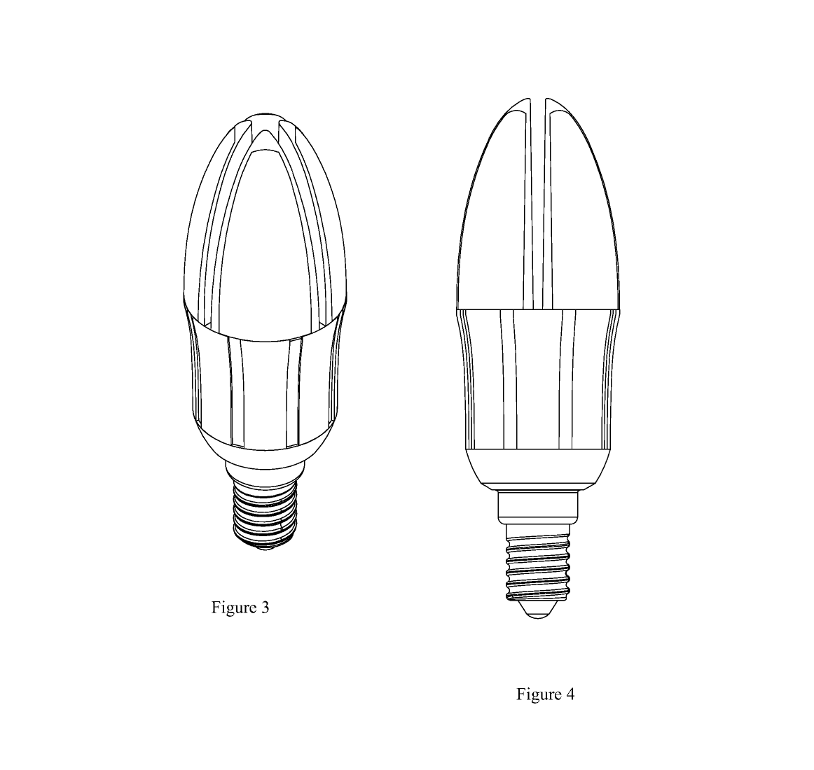

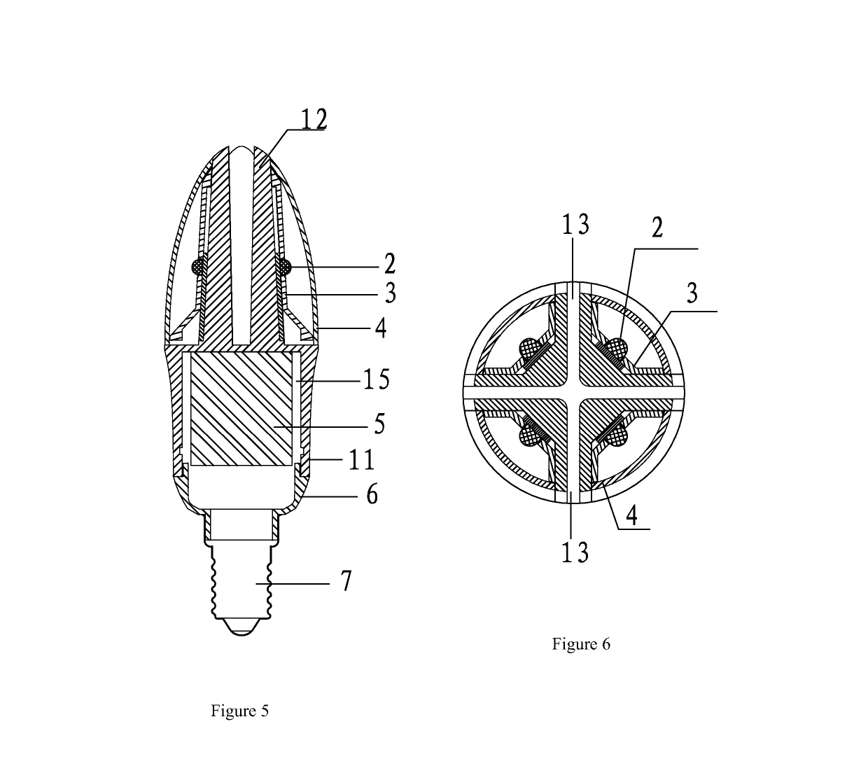

As shown in FIGS. 3, 4 and 5, in another embodiment of the present invention, the LED bulb with high heat dissipation includes the heat dissipating device 1, LED light source modules 2, reflecting shades 3, light transmitting shades 4, a driver 5, a lamp holder 6 and a lamp adapter 7.

The heat dissipating device 1 comprises a base 11 and two or more heat dissipating bodies 12. Each heat dissipating body 12 extends along the central axis of the base. The two or more heat dissipating bodies 12 are uniformly arranged around the central axis of the base, and a certain space is left between the adjacent heat dissipating bodies 12, so that heat dissipating channels 13 radiating outwardly from the central axis of the base are formed. Four heat dissipating bodies with V-shaped cross section are provided. The apex of the V-shaped cross section of the heat dissipating body 12 points to the central axis of the base, and the opening of the V-shaped cross section of the heat dissipating body 12 points outwards relative to the central axis of the base. The angle of the opening of the V-shaped cross section of the heat dissipating body is 90°. A hollow heat dissipating cavity 15 is constructed at one side of the base, opposite to the side where heat dissipating bodies are disposed.

As shown in FIG. 6, each LED light source module 2 is fixed at the bottom and/or on two side walls of an interior of the heat dissipating body with V-shaped cross section. Reflecting shades 3 are provided at the bottom and on two side walls of an interior of the heat dissipating body with V-shaped cross section. A light transmitting shade 4 is buckled on each of the heat dissipating bodies and covers the LED light source module 2 therein.

The lamp holder 6 is buckled with the base 11 through snap-fit, namely, the base 11 communicates with the atmosphere so as to form air convection.

The driver 5 is disposed inside the hollow heat dissipating cavity 15, and the driver is connected with the LED light source modules 2 through wires and connected with the lamp adapter 7 through the lamp holder 6 to realize electrical connections.

Preferably, in order to increase luminous efficiency of the LED bulb, the reflecting shades 3 are made of material with high reflecting rate, and the light transmitting shades 4 are made of transparent material with high light transmittance.

The heat dissipating bodies 12 in a variety of directions enable the heat generated by the LED light source modules 2 to efficiently be dissipated through the heat dissipating channels 13, and to be conducted to and dissipated through the heat dissipating fins 14. The large heat dissipating surface and the good heat dissipating effect are beneficial to the LED bulb with high power and prolong the service life of the product.

It will be understood by those skilled in the art that various modifications and variants for the present invention may be made therein without departing from the scope of the invention. If the modifications and variants are within the scope of the claims of the present invention and the equivalents, the present invention is also intended to include all these modifications and variants.

1. A heat dissipating device (1) for LED bulb, wherein: the heat dissipating device (1) comprises a base (11) and two or more heat dissipating bodies (12); the two or more heat dissipating bodies (12) are uniformly arranged around a central axis of the base; a certain space is left between adjacent heat dissipating bodies (12), so that heat dissipating channels (13) radiating outwardly from the central axis of the base are formed; the heat dissipating body (12) has a V-shaped cross section; an apex of the V-shaped cross section of the heat dissipating body (12) points to the central axis of the base, and an opening of the V-shaped cross section of the heat dissipating body (12) points outwards relative to the central axis of the base.

2. (canceled)

3. The heat dissipating device (1) for LED bulb according to claim 21, wherein: an angle of each opening of the V-shaped cross section of the heat dissipating body (12) is ranged from 10° to 180°.

4. The heat dissipating device (1) for LED bulb according to claim 1, wherein: the heat dissipating device (1) further comprises a plurality of heat dissipating fins (14); the base (11) is cylindrical; and the heat dissipating fins (14) extend outwards from an outer wall of the cylindrical base (11).

5. The heat dissipating device (1) for LED bulb according to claim 1, wherein: a hollow heat dissipating cavity (15) is constructed at one side of the base (11), opposite to another side where heat dissipating bodies are disposed.

6. The heat dissipating device (1) for LED bulb according to claim 1, wherein: the space between the adjacent heat dissipating bodies (12) is ranged from 0.5 mm to 20 mm.

7. (canceled)

8. The heat dissipating device (1) for LED bulb according to claim 1, wherein: an angle of the opening of the V-shaped cross section of the heat dissipating body (12) is 90°.

9. A LED bulb with high heat dissipation, comprising a heat dissipating device (1) and LED light source modules (2), wherein: the heat dissipating device (1) comprises a base (11) and two or more heat dissipating bodies (12); the two or more heat dissipating bodies (12) are uniformly arranged around a central axis of the base; a certain space is left between adjacent heat dissipating bodies (12), so that heat dissipating channels (13) radiating outwardly from the central axis of the base are formed; and the LED light source modules (2) are fixed on the heat dissipating bodies (12).

10. The LED bulb with high heat dissipation according to claim 9, wherein:
the heat dissipating body (12) has a V-shaped cross section; an apex of the V-shaped cross section of the heat dissipating body (12) points to the central axis of the base, and an opening of the V-shaped cross section of the heat dissipating body (12) points outwards relative to the central axis of the base;
each LED light source module (2) is fixed at a bottom and/or on two side walls of an interior of the heat dissipating body (12) with V-shaped cross section; reflecting shades (3) are provided at the bottom and on the two side walls of the interior of the heat dissipating body (12) with V-shaped cross section;
the LED bulb with high heat dissipation further comprises light transmitting shades (4); and each light transmitting shades (4) is buckled on a respective one of the heat dissipating bodies (12) and covers the LED light source module (2) therein.

11. The LED bulb with high heat dissipation according to claim 10, wherein: a hollow heat dissipating cavity (15) is constructed at one side of the base (11), opposite to another side where heat dissipating bodies are disposed.

12. The LED bulb with high heat dissipation according to claim 10, wherein: an angle of each opening of the V-shaped cross section of the heat dissipating body (12) is ranged from 10° to 180°.

13. The LED bulb with high heat dissipation according to claim 10, wherein: the heat dissipating device (1) further comprises a plurality of heat dissipating fins (14); the base (11) is cylindrical; and the heat dissipating fins (14) extend outwards from an outer wall of the cylindrical base.

14. The LED bulb with high heat dissipation according to claim 10, wherein: general outer contour of the light transmitting shades (4) is candle-shaped.
